(19) United States
(12) Patent Application Publication
(10) Pub. No.: US 2004/0116553 A1
(43) Pub. Date: Jun. 17, 2004

(54) Aqueous dispersion, ink for ink-jet printing, and image forming method

(76) Inventors: Masaki Nakamura, Tokyo (JP); Atsushi Tomotake, Tokyo (JP); Masato Tanaka, Niigata (JP)

Correspondence Address: Squire, Sanders & Dempsey L.L.P., Suite 300, One Maritime Plaza, San Francisco, CA, 94111, US

(21) Appl. No.: 10/729,329

(22) Filed: Dec. 5, 2003

(30) Foreign Application Priority Data
Dec. 12, 2002 (JP) JP2002-360631

(51) Int. Cl. C09D 11/00; C09C 1/44; C08K 5/00; C03C 17/00; C09D 5/00

(52) U.S. Cl. 523/160; 106/499; 106/476; 106/31.65; 524/800; 523/161

(57) ABSTRACT

A method for forming an aqueous dispersion of colored microparticles is disclosed. The method comprises the steps of; adding a compound having a hydrophilic portion and a hydrophobic portion or a hydrophilic colloid to an aqueous dispersion of a pigment particle, adding a monomer to the mixture, and adding a polymerization initiator to form a polymer on a surface of the pigment particle from the monomer.

An aqueous dispersion prepared by the method and an ink for ink jet containing the aqueous dispersion is also disclosed.

### FIELD OF THE INVENTION

The present invention relates to an aqueous dispersion, an ink for ink-jet printing, and an image forming method. Further relates to, in detail, an aqueous dispersion, an ink for ink-jet printing, and an image forming method improved in the clarity, glossiness and resistivity against frictional wearing of the image formed by them.

### BACKGROUND OF THE INVENTION

In ink-jet recording, an image or a character is recorded by flying a micro droplet to adhere to a recording medium. Such the method has merit such as that high speed, low noise, and multi-color printing can be easily realized.

Recently, the ink-jet printing using a dye ink is rapidly diffused accompanied with nearing of the image quality to that of silver halide photography and lowering of the price of the apparatus.

The dye is soluble in a solvent and the molecules of the dye forms color in a molecular state or a cluster state. Therefore, the absorption spectrum of the dye is sharp so that color with high purity and clearness is formed since the environment conditions of each of the molecules are near. Moreover, an ink jet recorded image having high clarity and clear color can be obtained since any granular pattern is not caused by granule of the dye and scattered or reflected light does not occur.

However, the dye has a shortcoming of low light fastness since reduction of the molecules is directly reflected to the density of the color when the molecules are destroyed by photo-reaction. In the quality of the ink-jet recorded image, the lowering of the image quality during storage is large even though the initial image quality is high, and any technique exceeding the silver halide photography in the storage ability of image is not appeared yet.

Other than the dye-ink, a pigment-ink using a pigment having high lightfastness is used as a colorant for a use requiring a high resistivity to light. However, the pigment is no match for the dye in the physical properties and the color reproducibility since the pigment image is easily influenced by scattered light so as to lower the clarity of the image since the pigment exists as pigment particles. Moreover, the coagulation of the pigment particles at the printed image surface causes lowering of the resistivity against frictional wearing and forming of the image having low glossiness and clarity.

High dispersion stability is generally required to the ink-jet ink using the pigment for avoiding block of the nozzle of an ink-jet head. However, the dispersion stability is frequently traded-off by the image forming property required according to the use.

An example of that is the trading-off of the high image quality to the resistivity against frictional wearing and the water-proof ability. The pigment image is inferior in the resistivity against frictional wearing since the image tends to be easily taken off by wearing since the image is formed on the surface of the recording medium. Moreover, the water-proof property is low because the ink is aqueous dispersible. Various methods have been proposed for overcoming such the shortcomings. For example, methods in which a water-soluble polymer molecule or a latex particle is added to the pigment ink such as those described in Patent Publications 1 through 4. However, the dispersion stability of the pigment-ink is lowered by the influence of the water-soluble polymer molecules or that of the latex particles even though the resistivity against frictional wearing and the water proof ability are considerably raised by such the methods. As a result of that, the stability of ink jetting is lowered so that the trading-off relation cannot be improved.

Besides, a polymer covered pigment has been proposed for making the compatibility of the resistivity against frictional wearing with the water-proof ability and the ink jetting stability.

The following methods have been proposed for the polymer covered pigment.

1) A monomer is absorbed onto the pigment surface and polymerized by addition of a polymerization initiator, such as that described in Patent Publications 5 and 6, or Publication 1.

2) The pigment is dispersed together with a polymerization initiator and then a monomer is added to the mixture and polymerized, such as that described in Patent Publication 7.

3) A polymerization initiator is bound to the surface of the pigment, and then a monomer is added and polymerized, such as that described in Publication 2.

4) Graft polymerization is performed on the surface of the pigment such as that described in Patent Publications 8 or 9.

5) An amphoteric polymer and the pigment are dispersed in an organic solvent, and then the dispersion phase is inversed to aqueous emulsion phase, such as that described in Patent Publication 10 or Publication 3.

Some degree of improvement in the resistivity against frictional wearing, the water-proof ability and the jetting stability can be attained by these methods. However, in the methods of 1) and 2), the polymerizable monomer is directly adsorbed to the pigment and the adsorption and the desorption of the monomer are in the equilibrium relation in such the system. Accordingly the amount of the monomer should be raised for increasing the covering thickness of the polymer. In such the case, a shortcoming is raised that resin particles are newly formed by polymerization of non-adsorbed monomer and the resin particles obstruct the stable jetting of the ink. In the method of 3), the covering amount of the polymer difficultly raised since the presence of the polymerization initiator is limited only at the surface of the pigment so that the polymerization of the monomer is performed only at the extremely near of the pigment surface. In the methods of 4), the complete covering of the pigment surface is difficult since the reactive group at the pigment surface is limited to a part. Furthermore, in the methods of 5), the polymer molecules are coagulates at the time of phase inversion for emulsification so as to form coagula of pigment when the amount of the polymer for increasing the thickness of the covering layer. As above-mentioned, polymer covered pigment having sufficient hickness of the polymer covering cannot be realized by the known method. Further technological development is demanded for obtaining a high quality image the same as that by the silver halide photographic method, the requirement for such the image is increasingly raised in the future.

Patent Publication 1: Japanese Patent Publication Open to Public Inspection, hereinafter referred to as JP O. P. I. Publication, No. 4-18462

Patent Publication 2: JP O. P. I. Publication, No. 6-145570

Patent Publication 3: JP O. P. I. Publication, No. 2000-351931

Patent Publication 4: JP O. P. I. Publication, No. 2002-30235

Patent Publication 5: JP O. P. I. Publication, No. 63-191864

Patent Publication 6: JP O. P. I. Publication, No. 4-234467

Patent Publication 7: JP O. P. I. Publication, No. 2002-161223

Patent Publication 8: Japanese Patent Examined Publication No. 1-49369

Patent Publication 9: JP O. P. I. Publication, No. 10-95943

Patent Publication 10: JP O. P. I. Publication, No. 10-140065

Publication 1: “Shikizai Kyokai Shi” 70, p. 503, 1997

Publication 2: “Shikizai Kyokai Shi” 69, p. 743, 1996

Publication 3: “Shikizai Kyokai Shi” 72, p. 748, 1998

### SUMMARY OF THE INVENTION

The object of the invention is to provide an aqueous dispersion, an ink for ink-jet printing and an image forming method improved in the clarity, glossiness and resistivity against frictional wearing by the use of a colored particle uniformly covered with a polymer shell having a desired thickness on the surface of pigment.

The object of the invention can be attained by the followings.

1. A method for forming an aqueous dispersion of colored microparticles comprising a pigment covered with a polymer, wherein the method comprises the steps of:

(a) mixing a hydrophilic colloid or a compound having a hydrophilic portion and a hydrophobic portion with a dispersion of the pigment particle to form a hydrophobic site which is capable of absorbing a monomer compound on a surface of the pigment;

(b) adding a monomer to the mixture obtained by the step (a); and

(c) adding a polymerization initiator to form the polymer on a surface of the pigment particle from the monomer.

2. In the method described in 1. above, the compound having a hydrophilic portion and a hydrophobic portion to a dispersion of the pigment particle to form a mixture is used in step (a).

3. In the method described in 1. or 2. above, the method further comprises steps after the step (c),

(d) adding another monomer having more hydrophilicity than that of the monomer used in the step of (c), and

(e) adding a polymerization initiator to form a polymer on a surface of the polymer on the pigment particles.

4. In the method described in one of 1. through 3. above, a ratio A/B of a weight A of the polymer to a weight B of the pigment covered with the polymer is from 0.6 to 10.0.

5. In the method described in one of 1. through 4. above, the pigment is an organic pigment or carbon black.

6. An aqueous dispersion of a colored microparticle comprising a pigment covered with a polymer, which is prepared by a method comprising the steps of:

forming a reaction site on the pigment by adding a hydrophilic colloid or a compound having a hydrophilic portion and a hydrophobic portion to an aqueous dispersion of the pigment;

(a) mixing a hydrophilic colloid or a compound having a hydrophilic portion and a hydrophobic portion with a dispersion of the pigment particle to form a hydrophobic site which is capable of absorbing a monomer compound on a surface of the pigment;

(b) adding a monomer to the mixture obtained by the step (a); and

(c) adding a polymerization initiator to form the polymer on a surface of the pigment particle from the monomer,

wherein a ratio A/B of a weight A of the polymer to a weight B of the pigment covered with the polymer is from 0.6 to 10.0.

7. In the aqueous dispersion described in 6. above, the aqueous dispersion comprises microparticles containing no pigment not more than 1.0% by weight based on the colored particles.

8. In the aqueous dispersion described in one of 6. or 8. above, the composition of the polymer at the position contacting to the surface of the pigment and that at the outermost portion are different from each other.

9. In the aqueous dispersion described in one of 6. through 8. above, the volume average diameter of the colored particles is within the range of from 10 nm to 200 nm.

10. In the aqueous dispersion described in one of 6. through 9. above, the pigment is at least one selected from the group consisting of an azo dye, a quinacridone dye and a phthalocyanine dye.

11. An ink for ink-jet printing containing the aqueous dispersion described in one of 6. through 10. above.

12. The ink for ink-jet printing described in 11. above, the viscosity of the ink is within the range of from 1.2 mPa·s to 15 mPa·s.

13. The ink for ink-jet printing described in 11. or 13 above, the surface tension of the ink is within the range of from 20 mN/m to 45 mN/m.

14. The ink for ink-jet printing described in one of 11. through 13. above, the pH value of the ink is within the range of from 6.0 to 11.0.

15. The ink for ink-jet printing described in one of 11. through 14. above, the content of an ink solvent is within the range of from 10% to 60% by weight based on the ink.

16. An ink-jet image forming method wherein an image is formed by using at least one ink described in 11. above.

17. An ink-jet image forming method of claim 16 wherein an image is formed on a porous ink-jet recording medium.

### DETAILED DESCRIPTION OF THE INVENTION

It has been found as a result of the investigation by the inventors on the aqueous dispersion of a colored microparticle comprising a polymer covered pigment particle that an aqueous dispersion, an ink for ink-jet printing and an image forming method each excellent in the clarity, glossiness and resistivity against frictional wearing of image can be realized by the use of such the colored microparticles prepared by the followings: to make the ratio A/B of the weight A of the polymer covering the pigment surface to the weight B of the pigment to from 1.2 to 10.0; to make the ratio A/B of the weight A of the polymer covering the pigment surface to the weight B of the pigment to from 0.6 to 10.0 wherein the polymer covering the pigment is formed by polymerization of monomers previously adsorbed on the pigment surface and the pigment is an organic pigment or carbon black; or to make the ratio A/B of the weight A of the polymer covering the pigment surface to the weight B of the pigment to from 0.6 to 10.0 wherein the polymer covered pigment is formed by adsorbing a compound having a hydrophilic portion and a hydrophobic portion or a protective colloid to form a reaction site, adsorbing a monomer to the reaction site and polymerizing the monomer to form colored microparticle which is uniformly covered by a polymer shell having a desired thickness; and to prepare a colored microparticle in which the composition of the polymer shell at the portion contacted with the pigment is different from that at the portion contacted with the aqueous medium.

The inventors suppose that it is necessary to make the amount of the polymer covering the pigment to a suitable thickness for obtaining an image with high quality equal to that of silver halide photograph. It is found that the amount of polymer covering the pigment surface can be optionally controlled by previously forming a hydrophobic adsorption portion on the pigment surface, successively supplying a monomer to the hydrophobic adsorption portion and polymerizing monomer so that the pigment surface can be covered by the polymer shell having the desired thickness. Moreover, the composition of the covering polymer can be continuously varied from the side near the pigment surface to the side of the hydrophilic medium by varying the composition of the successively supplied monomer. Consequently, it is made possible to provide a thick layer of transparent polymer contributing to the glossiness on the pigment surface and to further provide a thin layer of polymer necessary for dispersion on outside of the thick polymer layer.

It is further found that the followings are preferable for enhancing the effects of the invention: to use an organic pigment of carbon black as the pigment; to use at least one dye selected from azo pigments, quinacridone pigments, and phthalocyanine pigments; to make the ratio of microparticles containing no pigment to the total dispersed microparticles including the colored particles to not more than 1.0% by weight; to make the volume average particle diameter of the colored microparticles to from 10 nm to 200 nm; to make the viscosity of the ink for ink-jet printing using the colored microparticles to from 1.2 mPa·s to 15 mPa·s; to make the surface tension of the ink to from 20 mN/m to 45 mN/m; to make the pH value of the ink to from 6 to 11; to make the solvent content of the ink to from 1% to 60% by weight; or to use a porous ink-jet recording medium for forming an image using.

The invention is described in detail below.

In the aqueous dispersion according to the invention comprising the colored microparticles each comprising the pigment covered by the polymer, the ratio A/B of the weight A of the polymer covering the pigment to the weight B of the pigment is within the range of from 1.2 to 10.0.

The core-shell type colored microparticle according to the invention can be prepared by the following methods by using the microparticle of the pigment as the core and providing the polymer shell onto the core particle: the method described in JP O. P. I. Publication No. 8-71405 by which the pigment particles are dispersed by the polymer and the polymer is removed by an organic solvent, and then the particles are emulsified in water by phase inversion; the method described in “Shikizai Kyokai Shi” 70, 503, 1997, by which monomer is adsorbed onto the surface of the pigment particle and then polymerized; the method described in “Shikizai Kyokai Shi” 69, 743, 1996, by which an polymerization initiator is previously introduced to the surface of the pigment particle and then polymerized together with a monomer; a method by which a polymer dispersant is added and adsorbed to an aqueous suspension of polymer as a core; and a method by which polymer dissolved in an organic solvent is gradually dropped so as to adsorb the polymer to the core surface simultaneously precipitation of the polymer. Moreover, the polymer covered pigment can be prepared by a method in which the pigment is kneaded with polymer and dispersed in an aqueous system, and it is further possible to form the shell using thus prepared particle as the micro core particle by the forgoing methods.

In the invention, the method is preferable by which the monomer is gradually dropped into an aqueous suspension of the pigment to be previously adsorbed onto the pigment surface and then polymerize the monomer.

It is preferable in the invention to use the colored microparticle comprising the pigment particle covered by polymer which formed by adsorbing the monomer onto the pigment surface and them polymerizing the monomer. In the system, the pigment is an organic pigment or carbon black and the ratio A/B of the weight A of the covering polymer to the weight B of the polymer is preferably from 0.6 to 10.0, more preferably from 1.2 to 10.0.

It is preferable to contain the colored microparticle which is prepared by adsorbing the monomer to a reaction site formed by absorbing a compound having a hydrophilic portion and a hydrophobic portion or a protective colloid and polymerizing the monomer to cover the pigment surface by thus formed polymer, further in such the system, the pigment is preferably an organic pigment or carbon black and the ratio A/B of the weight A of the covering polymer to the weight B of the pigment covered by the polymer is preferably from 0.6 to 10.0, and more preferably from 1.2 to 10.0.

The weight of the pigment particles and that of the polymer covering the pigment particle can be easily determined by measuring the weight of the pigment and the polymer by thermal mass spectrometry, NMR, or colorimetry by IR or visible ray.

The colored microparticle prepared by the method, by which the reaction site is formed at the surface of the pigment particle by adsorbing the compound having the hydrophilic portion and the hydrophobic portion or the protective colloid and the monomer is adsorbed to the reaction site and then polymerize the monomer to form the polymer covering the pigment surface is described below; such the colored particle is particularly preferred embodiment of the invention.

The compound having the hydrophilic portion and the hydrophobic portion is added to an aqueous dispersion of the pigment and sufficiently stirred. It is supposed that the surface of the pigment is made so as to be easily adsorbed by the monomer by such the treatment. The monomer is added to the dispersion and sufficiently stirred so that the monomer, is fixed at the surface of the pigment particle. Then the polymerization initiator is added for polymerizing the monomer to form the polymer on the pigment particle surface. By this method, the shell can be uniformly formed on each of all the pigment particles with a little formation of new polymer particles in the course of the polymerization process and the polymer shell having the necessary thickness can be formed. Moreover, the polymer covering layer in which the monomer composition is varied between the pigment surface to the shell surface can be formed by successively changing the kind of the monomer in the course of the addition thereof.

Examples of compounds having a hydrophilic part and a hydrophobic part include surfactants, emulsifying agent and dispersing agent.

Examples of the cationic surfactant include aliphatic amine salts, aliphatic quaternary ammonium salts, benzalkonium chlorides, benzethonium chloride, pyridinium salts, and imidazolinium salts.

Examples of the anionic surfactant include fatty acid salts, N-acyl-N-methylglycine salt, N-acyl-N-methyl-β-alanine salt, N-acylglutamic acid salt, alkylether carboxylic acid salts, acylated peptides, alkylsulfonic acid salts, alkylbenzene sulfonic acid salts, alkylnaphthalene sulfonic acid salts, dialkylsulfosucccinic acid ester salts, alkylsulfoacetic acid salts, α-olefinesulfonic acid salts, N-acylmethyltaurine, sulfonated oil, higher alcohol sulfuric acid esters, salts of esters of higher alcohol with sulfuric acid, salts of esters of secondary higher alcohol with sulfuric acid, alkylethersulfates, secondary higher alcohol ethoxysulfates, polyoxyethylenealkyl phenyl ether sulfates, fatty acid alkylolamide sulfates, alkyletherphosphates, alkylphosphates.

Examples of the amphoteric surfactant include bataines having an anion from a carboxyl group or a sulfo group, amino carboxylic acid salts, and imidazolinium betaines.

Examples of the nonionic surfactant include polyoxyethylene alkyl ether, polyoxyethylene secondary alkyl ether, polyoxyethylene alkylphenyl ether (for example, Emulgen 911), polyoxyethylene sterol ether, polyoxyethylene lanoline derivatives, polyoxyethylenepolyoxypropylene alkyl ether (for example, New Pole PE-62), polyoxyethylene glyceride, polyoxyethylene castor oil, hardened castor oil, polyoxyethylene sorbitan fatty acid ester, polyoxyethylene sorbitol fatty acid ester, polyoxyethylene glycol fatty acid ester, monoglycerides, polyglycerides, sorbitan fatty acid ester, propylene glycol fatty acid ester, sucrose fatty acid ester, fatty acid alkanol amide, polyoxyethylene fatty acid amide, polyoxyethylene alkylamine, alkylamine oxides, acetylene glycol, and acetylene alcohol.

Other surfactants include, for example, Dispersant SNB, MS, N, SSL, ST and P (names of the products) manufactured by Kao Corp.

A water-soluble resin can also be used as the polymer surfactant. Examples of preferably usable water-soluble resin include a styrene-acrylic acid-alkyl acrylate copolymer, a styrene-acrylic acid copolymer, a styrene-maleic acid-alkyl acrylate copolymer, a styrene-maleic acid copolymer, a styrene-methacrylic acid-alkyl acrylate copolymer, a styrene-methacrylic acid copolymer, a styrene-maleic acid half ester copolymer, and a vinylanphthalene-maleic acid copolymer. Another example of the polymer surfactant is an acryl-styrene resin such as Johncryl, produced by Johnson Co., Ltd. Two or more kinds of such the polymer surfactant may be used with together.

The used amount of the surfactant or emulsifying agent is preferably 1-10,000 parts and more preferably 10-1,000 parts by weight with respect to 100 parts by weight of pigment.

Listed as water-soluble protective colloids are polyvinyl alcohols such as partially saponified polyvinyl alcohol, completely saponified polyvinyl alcohol, and modified polyvinyl alcohol; cellulose derivatives such as hydroxyethyl cellulose, hydroxypropyl cellulose, and carboxymethyl cellulose salts and natural polysaccharides such as guar gum. These may be employed individually or in combinations of several types.

The used amount of the water-soluble protective colloids is preferably 1-10,000 parts and more preferably 10-1,000 parts by weight with respect to 100 parts by weight of pigment.

The polymer covering the pigment is described below.

A compound selected from ethylene, propylene, butadiene, vinyl chloride, vinylidene chloride, vinyl acetate, styrene, (meth)acrylate, and (meth)acrylamide is usable as the monomer having a polymerizable unsaturated double bond for forming the polymer covering the pigment particle as the shell by adsorbing to the reaction site formed by the adsorption of the compound having the hydrophilic portion and the hydrophobic portion. It is preferable that a monomer having a hydrophobic portion only such as styrene and an acrylate having a group from —CH₃ to —C₁₆H₃₇ as the ester portion is used in combination with a monomer having a hydrophilic portion, for example, a monomer having a hydroxyl group such as hydroxyethyl(meth)acrylate, a monomer having a carboxylic acid group such as (meth)acrylic acid, itaconic acid, and maleic acid, a monomer having a sulfonic group such as styrenesulfonic acid, and sulfobutyl(meth)acrylate, or a monomer having an amido group such as (meth)acrylamide.

Monomers having a hydrophilic part include a reactive emulsifying agent. Examples thereof are compounds represented by Formula (1) to (3).

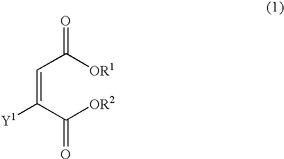

In the formula, R¹ represents a straight chain alkyl group or a branched alkyl group having 7-20 carbon atoms, or a substituted or unsubstituted aromatic group. Examples thereof include a straight chain alkyl group such as a heptyl, octyl, nonyl, decyl and dodecyl group, a branched alkyl group such as 2-ethylhexyl group, and an aromatic group such as a phenyl, nonylphenyl and naphthyl group.

R² represents a group having a polymerizable group capable of being radically polymerized, whose examples includes ethylenically unsaturated group such as an acrylate, methacrylate and maleimide group. Y¹ represents sulfonic acid, carboxylic acid or salts thereof.

It is possible for a skilled person in this industry to synthesize the compounds represented by Formula (1), employing conventional methods. Further, the aforesaid compounds are readily commercially available. Listed as such commercially available compounds may be, for example, “LATEMUL S-120”, “LATEMUL S-120A”, “LATEMUL S-180”, “LATEMUL S-180”, and “LATEMUL S-180A”, manufactured by Kao Corp. and “ELEMINOL JS-2”, manufactured by Sanyo Kasei Kogyo Co.

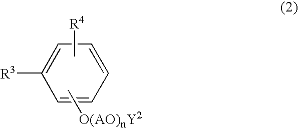

In the formula, R³ and R⁴ each is as defined for each of R¹ and R² in General Formula (1), Y² represents a hydrogen atom, sulfonic acid and salts thereof, or carboxylic acid and salts thereof, AO represents alkylene oxide, and n represents a degree of polymerization of alkylene oxide.

It is possible for a skilled person in this industry to synthesize the compounds represented by Formula (2), employing conventional methods. Further, the aforesaid compounds are readily commercially available. Listed as such commercially available compounds may be, for example, NE Series such as “ADEKA REASOAP NE-10”, “ADEKA REASOAP NE-20”, or “ADEKA REASOAP NE-30”, and SE Series such as “ADEKA REASOAP SE-10”, “ADEKA REASOAP SE-20N”, or “ADEKA REASOAP SE-30N”, manufactured by Asahi Denka Co., Ltd., and RN Series such as “AQUARON RN-10”, “AQUARON RN-20”, “AQUARON RN-30”, or “AQUARON RN-50”, and HS series such as “AQUARON HS-5” “AQUARON HS-10” “AQUARON HS-20” or “AQUARON HS-30”, and AQUARON BC Series, manufactured by Dai-ichi Kogyo Seiyaku Co., Ltd.

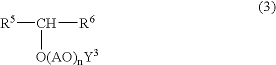

In the formula, R⁵, R⁶, Y³ and AO each is as defined for each of R¹, R², Y³, and AO in Formula (2), and n represents a degree of polymerization of alkylene oxide.

It is possible for a skilled person in this industry to synthesize the compounds represented by Formula (3), employing conventional methods. Further, the aforesaid compounds are readily commercially available. Listed as commercially available compounds may be, for example, “AQUARON KH-05”, “AQUARON KH-10”, and “AQUARON KH-20”, manufactured by Dai-ichi Kogyo Seiyaku Co., Ltd.

In aforesaid Formulas (2) and (3), average degree n of polymerization of the alkylene oxide chain (AO) is preferably 1-10. For example, listed may be aforesaid “AQUARON KH-05”, “AQUARON KH-10” “AQUARON HS-05”, and “AQUARON HS-10”, manufactured by Dai-ichi Kogyo Seiyaku Co., Ltd.

Reactive emulsifiers are preferably anionic. Listed as these may be, for example, aforesaid “ADEKA REASOAP SE Series” (manufactured by Asahi Denka Co., Ltd.), “AQUARON HS Series” (manufactured by Dai-ichi Kogyo Seiyaku Co., Ltd.), “LATEMUL S Series” (manufactured by Kao Corp.), and “ELEMINOL JS Series” (manufactured by Sanyo Chemical Co., Ltd.).

These monomers may be added in a state of previously prepared uniform solution or while changing the composition of the monomer. It is preferred that the pigment surface is covered by polymerization of the monomer principally composed the monomer having the hydrophobic portion only in the first half, and the monomer having the hydrophilic portion is mixed with the monomer having only the hydrophobic portion in the later half of the polymerization so as to provide hydrophilicity to the surface of the pigment particle.

There is no limitation on the polymerization initiator to be used for polymerizing the monomer. For example, a peroxide compound such as benzoyl peroxide, di-t-butyl peroxide, cumene hydroperoxide, t-butyl peroxide, and 2-ethyl hexanoate; and an azo compound such as azo-bis-isobutylnitoryl and azo-bis-isovarelnitoryl, are usable.

In the invention the content of the polymer microparticles containing no pigment in all the microparticles including the colored microparticles is preferably not more than 1.0% by weight, more preferably from 0 to 1.0% by weight, and further preferably from 0.1 to 1.0% by weight. As the method for making the content of the polymer microparticles containing no pigment to the condition according to the invention, the foregoing methods for preparing the colored microparticles are applicable and the method in which the monomer is adsorbed at the reaction site formed by adsorbing the compound having the hydrophobic portion and the hydrophilic portion or the protective colloid, and polymerized to form the polymer covering the pigment surface is preferably applicable.

In the invention, “the polymer microparticle containing no pigment” is a particle which has a pigment content of from 0 or less than 0.1% and does not contribute at all as the colored particle to the image density.

In the invention, the content of the polymer microparticles containing no pigment is measured by the following procedure: the colored microparticle dispersion is added to solution, for example, mixture of water and methanol, in which the ratio of the solvents is optionally controlled, and separated by centrifugal treatment into the polymer microparticles containing no pigment which contained in the supernant liquid and the colored microparticles as the precipitate A, since the specific gravity of the polymer microparticle containing no pigment is generally smaller than that of the colored particle containing the pigment. Then the precipitate A is dried and the weight of the dried precipitate is measured. Next, the colored microparticle dispersion is diluted by methanol and subjected to the centrifugal treatment so as to separate the precipitate including both of the polymer microparticles containing no pigment and the colored microparticles containing the pigment. Then the precipitate is dried and the weight of the dried precipitate B is measured. The content of the polymer microparticles containing no pigment can be determined by the following equation.

Polymer microparticle content={[Dried weight of Precipitate B−Dried weight of Precipitate A]/Dried weight of Precipitation B}×100%

It is important to evaluate practical core-shell formation. In the present invention, since the diameter of each particle is markedly small, to such a degree of less than or equal to 200 nm, analytical methods are limited from the viewpoint of resolution. Employed as analytical methods, which achieve the purposes, may be TEM and TOF-SIMS. When fine core-shell particles are observed utilizing TEM, a dispersion is applied onto a film comprised of carbon and subsequently dried, whereby the resultant coating may be observed. When an image observed utilizing the TEM is an image of only an organic material, the image is low in contrast. Therefore, in order to identify core-shell formation, it is desirable to dye the particles employing osmium tetraoxide, ruthenium tetraoxide, chlorosulfonic acid/uranyl acetate, or silver sulfide. Only core particles are dyed and the resultant particles are observed utilizing said TEM and compared to shell particles. Further, shell particles and non-shell particles are blended and subsequently dyed. It is then confirmed that the ratio of particles having a different degree of dying corresponds to the presence and absence of shell particles.

In a mass spectrometer such as TOF-SIMS, it is confirmed that by forming a shell on the surface of particles, the amount of colorants adjacent to the surface decreases compared to the formation of the core alone. When the colorants do not contain an element which is contained in a core-shell polymer, it is possible to confirm the formation of the shell containing a lesser amount of colorants utilizing the element as a probe.

When no such element is available, it is possible to compare the content of the colorants in the shell to that of particles having no shell, employing a suitable dyeing agent. The core-shell formation can more clearly be observed in such a manner that core-shell particles are buried into an epoxy resin, and an ultra-thin slice is cut employing a microtome, followed by dying the resultant slice. When polymers or colorants comprise an element which is employed as a probe, it is possible to estimate core-shell compositions as well as the amount of the colorants distributed in the core as well as in the shell, employing TOF-SIMS or TEM.

In the invention, the volume average diameter of the colored microparticles is preferably from 10 nm to 200 nm.

With respect to the core/shell colored microparticle of the invention, the effect of enclosing the pigment by the shell polymer is reduced when the volume average particle diameter is less than 5 nm since the surface area per unit volume becomes very large. On the other hand, the head tends to be blocked and precipitation of the particles in the ink tends to occur so that the standing stability of the ink is degraded when the average diameter of the colored microparticles exceeds 200 nm. Accordingly, the average diameter of the colored microparticles is preferably from 5 to 200 nm and more preferably 10 to 150 nm. When the colored microparticles having the average diameter exceeding 150 nm is used in an aqueous ink for ink-jet printing, the glossiness is degraded in the image recorded on a glossy recording medium and the clarity is considerably degraded in the image formed on a transparency recording medium. When the average diameter of the colored microparticles is less than 10 nm, the stability of the colored microparticles tends to be lowered and the storage stability of the ink tends to be degraded. The average diameter of from 10 to 100 nm is most preferable.

A volume average particle diameter can also be determined by use of a dynamic light scattering method. Examples of measuring apparatus are: a laser particle analyzing system manufactured by Otsuka Electronics Co., Ltd.; and Zetasizer 1000HS manufactured by Malvern Instruments Ltd.

The pigment usable in the invention is described below.

Known pigments may be used as the pigment in the invention without any limitation. The pigment preferably usable in the invention include is an organic pigment or carbon black. Examples of such the pigment include an organic pigment, for example, an azo pigment such as an azo lake pigment, an insoluble azo pigment, a condensed azo pigment, and a chelate azo pigment, a polycyclic pigment such as a phthalocyanine pigment, perylene and a perylene pigment, an anthraquinone pigment, a dioxazine pigment, a thioindigo pigment, and an isoindolinone pigment, a dye lake pigment such as a basic dye type lake pigment, and an acidic dye type lake pigment, and a nitro pigment, a nitroso pigment, aniline black, and a day light fluorescent pigment, and an inorganic pigment such as carbon black. It is preferred that the pigment is at least one selected from the azo pigments and the phthalocyanine pigments.

Preferable pigments are exemplified.

Specifically preferable examples of carbon black are listed below.

Mitsubishi Kasei Corp.: No. 2300, No. 900, MCF-88, No. 33, No. 40, No. 45, No. 52, MA7, MA8, MA100, and No.2200B. Columbia Corp.: Raven 700, Raven 5750, Raven 5250, Raven 5000, Raven 3500, and Raven 1255.

Cabot Corp.: Regal 400R, Regal 330R, Regal 660R, Mogul L, Monarch 700, Monarch 800, Monarch 880, Monarch 900, Monarch 1000, Monarch 1100, Monarch 1300, and Monarch 1400. Degussa AG: Color Black FW1, Color Black FW2, Color Black FE2V, Color Black FW18, Color Black FW20, Color Black S150, Color Black S160, Color Black S170, Printex 35, Printex U, Printex V, Printex 140U, Printex 140V, Special Black 6, Special Black 5, Special Blach 4A, and Special Black 4. The Kansai Coke and Chemicals Co., Ltd.: Maxsoab G-40, Maxsoab G-15, and Maxsoab G-08.

Pigments for yellow include C. I. Pigment Yellow 1, C. I. Pigment Yellow 2, C. I. Pigment Yellow 3, C. I. Pigment Yellow 12, C. I. Pigment Yellow 13, C. I. Pigment Yellow 14, C. I. Pigment Yellow 16, C. I. Pigment Yellow 17, C. I. Pigment Yellow 73, C. I. Pigment Yellow 74, C. I. Pigment Yellow 75, C. I. Pigment Yellow 83, C. I. Pigment Yellow 93, C. I. Pigment Yellow 95, C. I. Pigment Yellow 97, C. I. Pigment Yellow 98, C. I. Pigment Yellow 114, C. I. Pigment Yellow 128, C. I. Pigment Yellow 129, C. I. Pigment Yellow 151, and C. I. Pigment Yellow 154.

Pigments for magenta include C. I. Pigment Red 5, C. I. Pigment Red 7, C. I. Pigment Red 12, C. I. Pigment Red 48(Ca), C. I. Pigment Red 48(Mn), C. I. Pigment Red 57(Ca), C. I. Pigment Red 57:1, C. I. Pigment Red 112, C. I. Pigment Red 123, C. I. Pigment Red 168, C. I. Pigment Red 184, and C. I. Pigment Red 202.

Pigments for cyan include C. I. Pigment Blue 1, C. I. Pigment Blue 2, C. I. Pigment Blue 3, C. I. Pigment Blue 15:3, C. I. Pigment Blue 15:34, C. I. Pigment Blue 16, C. I. Pigment Blue 22, C. I. Pigment Blue 60, C. I. Vat Blue 4, and C. I. Vat Blue 60.

It is preferable that the pigment particle to be used in the invention is micronized in the dispersed state before the covering the surface thereof by the polymer. On this occasion, the pigment dispersed by a usual surfactant or a polymer dispersant, or a self-dispersible pigment may be used. The self-dispersible pigment is a pigment given dispersibility by substituting the surface with a hydrophilic group such as a sulfonic acid.

In the invention, “the pigment particle having a hydrophilic group” includes a pigment of which surface is directly modified by a hydrophilic group, and an organic pigment having an organic pigment mother nucleus to which an ionic group is bonded directly or through a joint.

As the hydrophilic group, for example, a sulfonic acid group, a carboxyl group, a phosphoric acid group, a boric acid group, and a hydroxyl group are applicable. Among them, the sulfonic acid group and the carboxyl group are preferable and the sulfonic acid group is further preferable.

In the invention, as the method for obtaining the pigment particle having a hydrophilic group, for example, the following methods are applicable: the methods described in WO Publication 97/48769, JP O. P. I. Publication Nos. 11-57458, 11-189739 and 2000-265094 by which the surface of the pigment particle is directly modified by a sulfonation agent or an oxidant; the methods described in JP O. P. I. Nos. 11-49974, 2000-273383, and 2000-303014 by which a pigment derivative is adsorbed to the pigment particle surface by a milling treatment; and the methods described in Japanese Patent Application Nos. 2000-377068, 2001-1495, and 2001-234966 by which the pigment is dissolved in a solvent together with a pigment derivative and crystallized in a poor solvent. The pigment particle having a hydrophilic group on the surface thereof can be easily obtained by any of the above-mentioned methods.

Methods for dispersing said pigments are not particularly limited. Employed as said methods may be, for example, various methods employing, for example, a ball mill, a sand mill, an attriter, a roll mill, an agitator, a Henschel mixer, a colloid mill, an ultrasonic homogenizer, a pearl mill, a wet type jet mill, and a paint shaker.

Listed as usable pigment dispersing agents are, for example, surface active agents such as higher fatty acid salts, alkyl sulfates, alkyl sulfonates, sulfosuccinates, naphthalenesulfonates, alkyl phosphates, polyoxyalkylene alkyl ether phosphates, polyoxyalkylene alkyl phenyl ether, polyoxyethylene polyoxypropylene glycol, glycerin ester, sorbitan ester, polyoxyethylene fatty acid amide, and amine oxide, or block copolymers and random copolymers comprised of at least two types of monomers selected from the group consisting of styrene, styrene derivatives, vinylnaphthalene derivatives, acrylic acid, acrylic acid derivatives, maleic acid, maleic acid derivatives, itaconic acid, itaconic acid derivatives, fumaric acid, and fumaric acid derivatives, and salts thereof.

A volume average particle diameter of the pigment dispersion is preferably not less than 10 nm and not more than 180 nm, and more preferably 10 to 140 nm. The volume average particle diameter is measured by a particle analyzer in a market utilizing a method of light scattering, electrophoresis, laser Doppler and so on.

The water-based ink employing aqueous dispersion of the invention is described.

The water-based ink of the present invention, utilizing water as a medium, comp rises dispersed colored particles containing the above colorant, and various kinds of additives may be optionally added to the ink. Examples of the additives include a wetting agent such as polyhydric alcohols, a dispersant, an inorganic salt, a surfactant, an antiseptic agent, an antifungal agent, a pH adjusting agent, an antifoaming agent of a silicone type, a chelating agent such as EDTA, and an oxygen absorbing agent such as a sulfite.

The viscosity of said ink compositions is preferably not less than 1.2 mPa·s and not morr than 15 mPa·s. The viscosity can be adjusted by employing a viscosity modifying agent and changing concentration of content of composition including colored particles.

The surface tension of said ink compositions is preferably at least 20 mN/m, and not more than 50 mN/m, and more preferably 30-40 mN/m The surface tension can be adjusted by employing a surfactant and changing its kind and concentration.

In the present invention pH of ink is at least 6.0 and not more than 10.0, and more preferably 8.0 to 10.0. For adjusting pH of ink pH adjusting agent is used, whose example includes an organic amine such as monoethanol amine, dimethanol amine, triethanol amine, an inorganic alkali agent such as hydroxide of alkali metal such as sodium hydroxide, lithium hydroxide, potassium hydroxide, an organic acid, and mineral acid.

Content of ink solvent is preferably 1-60 weight %, more preferably 10-50 weight %, and particularly preferably 20-50 weight % based on ink.

Listed as water-soluble organic solvents are, for example, alcohols (for example, methanol, ethanol, propanol, isopropanol, butanol, isobutanol, secondary butanol, tertiary butanol, pentanol, hexanol, cyclohexanol, and benzyl alcohol); polyhydric alcohols (for example, ethylene glycol, diethylene glycol, triethylene glycol, polyethylene glycol, propylene glycol, dipropylene glycol, polypropylene glycol, butylene glycol, hexanediol, pentanediol, glycerin, hexanetriol, and thiodiglycol); polyhydric alcohol ethers (for example, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monobutyl ether, ethylene glycol monomethyl ether acetate, triethylene glycol monomethyl ether, triethylene glycol monoethyl ether, triethylene glycol monobutyl ether, ethylene glycol monophenyl ether, and propylene glycol monophenyl ether); amines (for example, ethanolamine, diethanolamine, triethanolamine, N-methyldiethanolamine, N-ethyldiethanolamine, morpholine, N-ethylmorpholine, ethylenediamine, diethylenediamine, triethylenetetraamine, tetraethylenepentaamine, polyethyleneimine, pentamethyldiethylenetriamine, and tetramethylpropylenediamine); amides (for example formamide, N,N-dimethylformamide, and N,N-dimethylacetamide); heterocyclic rings (for example, 2-pyrrolidone, N-methyl-2-pyrrolidone, cyclohexylpyrrolidone, 2-oxazolidone, and 1,3-dimethyl-2-imidazolidinone); sulfoxides (for example, dimethylsulfoxide); sulfones (for example, sulfolane); urea; acetonitrile; and acetone.

A anionic, nonionic or cationic surfactant may be employed in the ink jet ink composition in the invention. Examples of the surfactant preferably used in the aqueous pigment ink according to the invention include an anionic surfactant such as a dialkylsulfosuccinate, an alkylnaphthalenesulfonate and a fatty acid salt; a nonionic surfactant such as a polyoxyethylene alkyl ether, a polyoxyethylene alkylaryl ether, an acetylene glycol and a polyoxyethylene•polyoxypropylene block copolymer; and a cationic surfactant such as an alkylamine salt and a quaternary ammonium salt. Among them, the anionic surfactant and the nonionic surfactant are preferred.

A polymer surfactant is also employed in the present invention.

The ink jet ink composition of the invention may further contain water soluble polymer or water insoluble polymer dispersion.

Examples of the natural water-soluble polymer include a protein such as glue, gelatin, casein and albumin; a natural gum such as gum arabic and tragacanth gum; a glucoside such as saponin; an alginic acid derivative such as alginic acid, propylene glycol alginate, triethanolamine alginate and ammonium alginate; and a cellulose derivative such as methyl cellulose, carboxymethyl cellulose, hydroxyethyl cellulose and ethylhydroxyl cellulose.

Moreover, a synthesized polymer is also preferably usable as the water-soluble polymer. Examples of the synthesized polymer include an acryl resin such as a polyvinyl alcohol, a polyvinylpyrrolidone, a polyacrylic acid, an acrylic acid/acrylonitrile copolymer, a vinyl acetate/acrylate copolymer and acrylic acid/acrylate copolymer; a styrene/acrylic resin such as a styrene/acrylic acid copolymer, a styrene/methacrylic acid copolymer, a styrene/methacrylic acid/acrylate copolymer, a styrene/α-methylstyrene/acrylic acid copolymer and a styrene/α-methylstyrene/acrylic acid/acrylate copolymer; and a vinyl acetate copolymer such as a styrene/maleic acid, a styrene/α-methylstyrene/acrylic acid copolymer, a styrene/maleic anhydride styrene/α-methylstyrene/acrylic acid copolymer, a vinylnaphthalene/acrylic acid copolymer, a vinylnaphthalene/maleic acid copolymer, a vinyl acetate/ethylene copolymer, a vinyl acetate/vinylethylene fatty acid ester copolymer, a vinyl acetate/maleate copolymer, a vinyl acetate/crotonic acid copolymer, and a vinyl acetate/acrylic acid copolymer and a salt thereof. Among them, polyvinylpyrrolidone is particularly preferable example.

The water-insoluble-polymer dispersion (referred to latex hereafter) employed for the invention is not particularly restricted. Examples of the latexes include styrene-butadiene copolymers, polystyrene, acrylonitrile-butadiene copolymers, acrylic acid ester copolymers, polyurethane, silicone-acryl copolymers, acryl modified fluorine-containing resins, and the like. The latexes may be those in which polymer particles are dispersed in a dispersion medium in the presence or absence of an emulsifying agent. As an emulsifying agent, a surface-active agent is generally used, and a polymer having a water solubilizing group such as a sulfonic acid group or a carboxylic acid group (for example, a graft polymer having a water solubilizing group in the side chain or a polymer obtained by polymerizing a monomer having a water solubilizing group and a water insoluble monomer) is preferably used.

The ink of the present invention preferably contains soap free latexes. The soap free latexes herein referred to mean latexes which are prepared without employing emulsifying agents or latexes are prepared by using a polymer having a water solubilizing group such as a sulfonic acid group or a carboxylic acid group (for example, a graft polymer having a water solubilizing group in the side chain or a polymer obtained by polymerizing a monomer having a water solubilizing group and a water insoluble monomer) as an emulsifying agent.

Recently, other than latexes in which the whole of the latex polymer particles is uniform, there are core-shell type latexes in which the latex polymer particles have the difference in composition between the central portion and the peripheral portion in the polymer particles. In the invention, this type of latex also can be preferably used.

The average particle size of the latex polymer particles used in the ink of the present invention is preferably from 10 to 300 nm, and more preferably from 10 to 100 nm. When the average diameter of the latex polymer particles exceeds 300 nm, glossiness of images recorded tends to be degraded, and when the average particle size is less than 10 nm, water resistance or abrasion resistance may be degraded. It is possible to determine the particle size of the latex polymer particles, employing commercially available particle size measurement apparatus utilizing a light scattering method, an electrophoretic method, a laser Doppler method, and the like.

The ink according to the invention such conventional additives may be employed optionally as viscosity adjuster, resistivity adjuster, film forming agent, UV absorber, anti-oxidant, anti-fading agent, fungicidal agent and rust preventive agent, for the purpose of improving various characteristics such as stabilizing jetting, compatibility to print head or ink cartridge, storage stability, image store ability and so on. The additives include oil particles of, such as, fluid paraffin, dioctyl phthalate, tricresyl phosphate, silicon oil etc.; a UV absorbent disclosed in Japanese Patent O.P.I. Publication Nos. 57-74193, 57-87988 and 62-261476; an anti-fading agent disclosed in Japanese Patent O.P.I. Publication Nos. 57-74192, 57-87988, 60-72785, 61-146591, 1-95091 and 3-13376; and a fluorescent brightening agent disclosed in Japanese Patent O.P.I. Publication Nos. 59-42993, 59-52689, 62-280069, 61-24271 and 4-219266.

The ink jet recording mediums used in the invention include plain paper, coated paper, a swell type ink jet recording paper sheet, in which an ink receiving layer capable of absorbing ink and swelling is provided on a paper substrate, a void type ink jet recording paper sheet, in which a porous ink receiving layer is provided on a paper substrate, and ink jet recording resin sheet in which a substrate of resin such as polyethylene terephthalate is used instead of a paper substrate. The use of the porous ink jet recording sheet is preferable and can provide the excellent performance in the invention.

As the porous recording medium, porous type ink-jet recording paper and porous type ink-jet recording film are usable. They are each a recording medium having a porous layer capable of absorbing the ink. The porous layer is formed by soft coagulum mainly constituted by a water-soluble binder and an inorganic fine particle.

Various methods have been known for forming the pores in the layer, for example, the following methods are applicable: a method in which a uniform coating liquid containing two or more kinds of polymer is coated on a substrate and the pores are formed by the phase separation of the polymers in the course of drying of the coated layer; a method in which a coating liquid containing solid particles and a hydrophilic or hydrophobic binder is coated on a substrate and dried, and thus dried ink-jet recording paper is immersed in water or a liquid containing suitable organic solvent for dissolving the solid particles to form the pores; a method in which a coating liquid containing a substance capable of foaming on the occasion of layer formation is coated on a substrate and foam is formed from the substance in the course of drying to form the pores; a method in which a coating liquid containing porous fine particles and a hydrophilic binder is substrate to form the pores in or between the porous solid particles; and a method in which a coating liquid containing a hydrophilic binder and solid particles and/or fine oil droplets in an amount of equal or more volume of the hydrophilic binder is coated on the substrate to form the pores between the solid particles. The porous layer formed by any methods gives satisfactory results when the ink according to the invention is used.

The ink-jet head usable in the ink-jet image forming method according to the invention may be either an on-demand system or a continuous system. Any ink jetting system may be applicable. Examples of the ink jetting system include an electro-mechanical conversion system such as a single cavity type, a double cavity type, a bender type, a piston type, a share mode type and a shared wall type, an electro-thermal conversion system such as a thermal ink-jet type, and a bubble jet (R) type, a static attraction system such as an electric field controlling type, and a slit jet type, and an electric discharge system such as a spark jet type. Any of the foregoing jetting system is applicable.

### EXAMPLE

The present invention is described below referring examples.

### Example 1

<Preparation of Pigment Dispersion>

Preparation of Pigment Dispersion 1: Inventive Example

Fourteen grams of an aqueous dispersion of C. I. Pigment Red 112 dispersed by sodium 2-ethylhexyl sulfosuccinate with a pigment concentration of 10% by weight was added to 200 ml of deionized water. The mixture was put into a 200 ml cylindrical separable flask to which a thermal sensor, a nitrogen introducing pipe and a stirrer were attached.

To the mixture, 2.0 g of sodium dodecylsulfonate (SDS), and 0.4 g of styrene monomer were added and stirred for 1 hour at room temperature under a nitrogen gas stream. Then the inner temperature of the flask was gradually raised by 70° C., and 10 ml of an aqueous solution containing 0.1 g of potassium persulfate, and 1.4 g of styrene monomer was gradually dropped spending 6 hours while keeping the temperature. After the completion of the dropping, 0.4 g or a monomer mixture composed of styrene/methacrylic acid in a ratio of 1/1 was gradually added spending 2 hours, and further stirred for 2 hours. Thus shelling was finished.

The reaction liquid was cooled and a 0.2% aqueous solution of sodium hydroxide was added to adjust the pH of the reaction liquid to 8.2. Thereafter the reaction liquid was condensed and purified by an ultrafiltrater so that the pigment concentration was become to 10% by weight. Thus Pigment Dispersion 1 was prepared which contained colored microparticles covered with polymer.

Preparation of Pigment Dispersions 2 through 17: Inventive Example

Pigment Dispersions 2 through 17 were prepared in the same manner as in Pigment Dispersion 1 except that the kind and the amount of the monomer, the kind, the amount and the adsorption time of the surfactant, and the kind of the pigment were changed as show as in Table 1.

Preparation of Pigment Dispersion 18: Comparative Example

Pigment Dispersion 18 was prepared in the same manner as in Pigment Dispersion 1 except that sodium dodecylsulfate (SDS) was omitted.

Preparation of Pigment Dispersion 19: Comparative Example

Pigment Dispersion 19 was prepared in the same manner as in Pigment Dispersion 1 except that the polymerization was started by raising the temperature of the reaction liquid by 70° C. just after the addition of 0.2 g of sodium dodecysulfate and 0.15 g of styrene monomer under the nitrogen gas stream.

Preparation of Pigment Dispersions 20 and 21: Comparative Example

Pigment Dispersions 20 and 21 were prepared in the same manner as in Pigment Dispersions 18 and 19, respectively, except that C. I. Pigment Red 122 was replaced by carbon black (CB).

Preparation of Pigment Dispersion 22: Comparative Example

Twenty three point four grams of a polymer solution with a solid content of 48% by weight Aontaining methyl methacrylate (MMA)/butyl acrylate (BA)/2-hydroxyethyl methacrylate (HEMA)/mathacrylic acid (MAA) in a weight ratio of 70/4.3/15/10.7 was mixed with 14.25 g of C. I. Pigment Red 122, 0.75 g of dimethylaminomethylquinacridone, 76.9 g of methyl ethyl ketone, and 4.7 g of a melamine resin Super Beccamine L-109-60, produced by Dai Nihon Ink Co., Ltd., and dispersed using ceramic beads to make into a past state. Then 50 g of the past was mixed and stirred together with 0.4 g of diethanolamine and methyl ethyl ketone was removed by vacuum distillation. Thereafter, 50 g of deionized water was gradually added while applying ultrasonic wave so as to occur phase inversion, and remove methyl ethyl ketone by vacuum distillation to prepare Pigment Dispersion 22.

Preparation of Pigment Dispersion 23: Comparative Example

Pigment Dispersion 23 was prepared in the same manner as in Pigment Dispersion 1 except that the kind and the amount of monomer and surfactant were changed as shown as in Table 1.

The abbreviation of each of the compounds shown in Table 1 is as follows:

PR122: C. I. Pigment Red 122

CB: Carbon black

PB15:3: C. I. Pigment Blue 15:3

PY138: C. I. Pigment Yellow 138

IJX266: Cabojet IJX266

SDS: Sodium dodecylsulfate

SA 1: Demol MS (Condensed product of sulfonic acid-formalin), Kao Co., Ltd.

SA 2: Lebenol WX (Polyoxyethylene alkyl ether sulfate), Kao Co., Ltd.

SA 3: Johncryl 70 (Styrene-acryl type polymer dispersant), Johnson Polymer Co., Ltd.

SA 4: Emulgen 109 (Polyoxyethylene lauryl ether), Kao Co., Ltd.

St: Styrene

MMA: Methyl methacrylate

EHA: 2-ethylhexyl methacrylate

SMA: Stearyl methacrylate

MMA: Methacrylic acid

HEMA: 2-hydroxyethyl methacrylate

HS-10: Aquaron HS-10 (Acryl type reactive surfactant), Daiichi Kogyo Seiyaku Co., Ltd.

BA: Butyl acrylate

BMA: Butyl methacrylate

BzMA: Benzyl methacrylate

Monomer 1: St/MMA=7/3 in weight ratio

Monomer 2: St/MMA=3/1 in weight ratio

Monomer 3: St/MMA/EHA=7/2/1 in weight ratio

Monomer 4: St/MMA/SMA=2/1/1 in weight ratio

Monomer 5: ST/HEMA/MAA=2/1/1 in weight ratio

Monomer 6: St/Itaconic acid=1/1 in weight ratio

Monomer 7: BMA/BzMA=1/1 in weight ratio<

<Evaluation of the Pigment Dispersion>

Determination of Polymer Covering Ratio

Weight of the pigment and that of the polymer covering the pigment of the colored microparticles contained in each of the above-prepared pigment dispersions were determined by thermal mass spectrometry and the polymer covering ratio A/B was calculated according to the weight A of the polymer covering the pigment particle and the weight B of the pigment. As to pigments decomposable in the thermal mass spectrometry process, the sample was dissolved in sulfuric acid and the pigment weight B was measured by colorimetry. On the other hand, the total (A+B) of the weight A of the polymer and that of the pigment B was measured by centrifugal method. The polymer covering ratio A/B was calculated according to the above-measured values of A and (A+B).

Determination of Non-Colored Polymer Microparticle Content

With respect to the above-prepared pigment dispersions, the ratio of the polymer particles containing no pigment in weight percentage was determined by the following procedure.

To 100 parts of each of the pigment dispersions, 500 parts of a mixture of methanol/water in a ratio of 1/2 was added and subjected to a centrifugal separation treatment so that the polymer microparticles was removed and the colored microparticles were separated as precipitate. Then the precipitate was dried and the weight thereof (a) was measured. On the other hand, 100 parts of the dispersion was diluted by 500 parts of methanol and subjected to the centrifugal treatment in the same manner as above to separate precipitate containing both of the polymer microparticles and the colored microparticles. The precipitate was dried and the weight of the precipitate (b) was measured. The content of the polymer microparticles was calculated according to the following equation.

Polymer microparticle content={Weight of dried precipitate (b)−Weight of dried precipitate (a)/Weight of dried precipitate (b)}×100%

Determination of Volume Average Diameter of Colored Microparticles

Each of the above-prepared pigment inks was diluted by ultrapure water and the volume average diameter in nm was determined by Zetasizer 1000HS, manufactured by Malburn Co., Ltd.

The above-obtained results are shown in Table 1.

TABLE 1

| | | | | | | Pre-adding | | Post-adding | | | | | |
|---|---|---|---|---|---|---|---|---|---|---|---|---|---|
| | Kind | | | | | monomer | | monomer | | | Polymer | | |
| | of | Surfactant | | | Time | Kind and | | Kind and | | | covering | | |
| *4 | pigment | *5 | Kind | *5 | *1 | composition | *5 | composition | *5 | *6 | ratio | *2 | Remarks |
| 1 | PR122 | 1.4 | SDS | 2.0 | 1.0 | St | 1.8 | St/MAA = 1/1 | 0.4 | 78 | 1.0 | 0.33 | Inv. |
| 2 | PR122 | 1.4 | SDS | 3.0 | 1.0 | St | 0.6 | St/MAA = 1/1 | 0.4 | 89 | 0.7 | 0.94 | Inv. |
| 3 | PR122 | 1.4 | SDS | 2.0 | 1.0 | St | 6.0 | St/MAA = 1/1 | 0.4 | 102 | 2.1 | 0.32 | Inv. |
| 4 | PR122 | 1.4 | SDS | 4.0 | 1.0 | St | 12.0 | St/MAA = 2/1 | 0.6 | 150 | 5.0 | 0.10 | Inv. |
| 5 | PR122 | 1.4 | SDS | 2.0 | 1.0 | Monomer 1 | 3.0 | Monomer 5 | 0.4 | 84 | 0.9 | 0.37 | Inv. |
| 6 | PR122 | 1.4 | SA1 | 3.0 | 2.0 | St | 1.8 | Monomer 6 | 0.4 | 88 | 1.8 | 0.49 | Inv. |
| 7 | PR122 | 1.4 | SA2 | 3.0 | 2.0 | St | 1.8 | St/MAA = 1/1 | 0.4 | 94 | 1.6 | 0.31 | Inv. |
| 8 | PR122 | 1.4 | SA3 | 3.0 | 2.0 | St | 1.8 | St/MAA = 1/1 | 0.4 | 90 | 1.6 | 0.36 | Inv. |
| 9 | PR122 | 1.4 | SA4 | 2.0 | 1.0 | Monomer 1 | 1.2 | St/MAA = 1/1 | 0.6 | 120 | 1.5 | 0.32 | Inv. |
| 10 | PR122 | 1.4 | SDS | 3.0 | 1.0 | Monomer 3 | 0.9 | Aquaron HS-10 | 0.4 | 98 | 1.2 | 0.39 | Inv. |
| 11 | CB | 1.4 | SDS | 3.0 | 1.0 | St | 1.2 | St/MAA = 1/1 | 0.4 | 85 | 0.8 | 0.51 | Inv. |
| 12 | CB | 1.4 | SDS | 5.0 | 1.0 | St | 8.4 | St/MAA = 1/1 | 0.4 | 122 | 3.8 | 0.14 | Inv. |
| 13 | PB15:3 | 1.4 | SDS | 3.0 | 2.0 | St | 4.2 | Monomer 5 | 0.4 | 65 | 2.0 | 0.21 | Inv. |
| 14 | PY138 | 1.4 | SDS | 3.0 | 2.0 | St | 4.2 | St/MAA = 1/1 | 0.4 | 97 | 1.5 | 0.24 | Inv. |
| 15 | IJX266 | 1.4 | SDS | 3.0 | 1.0 | Monomer 4 | 4.2 | St/HEMA = 1/1 | 0.4 | 98 | 2.0 | 0.28 | Inv. |
| 16 | IJX266 | 1.4 | SA4 | 2.0 | 2.0 | St | 2.7 | St/MAA = 1/1 | 0.6 | 102 | 1.5 | 0.37 | Inv. |
| 17 | PR122 | 1.4 | SDS | 3.0 | 1.0 | Monomer 2 | 2.3 | — | — | 125 | 1.5 | 0.52 | Inv. |
| 18 | PR122 | 1.4 | — | — | 1.0 | St | 2.4 | St/MAA = 1/1 | 0.4 | 102 | 0.3 | 5.2 | Comp. |
| 19 | PR122 | 1.4 | SDS | 2.0 | 0 | St | 2.4 | St/MAA = 1/1 | 0.4 | 134 | 0.2 | 20.4 | Comp. |
| 20 | CB | 1.4 | — | — | 1.0 | St | 1.2 | St/MAA = 1/1 | 0.4 | 116 | 0.3 | 7.8 | Comp. |
| 21 | CB | 1.4 | SDS | 2.0 | 0 | St | 1.2 | St/MAA = 1/1 | 0.4 | 103 | 0.2 | 25.6 | Comp. |
| 22 | PR122 | 1.4 | — | — | — | Phase inversion method *3 | | | | 68 | 0.2 | 35.2 | Comp. |
| 23 | PR122 | 1.4 | HS-10 | 3.0 | 1.0 | St | 1.8 | Monomer 7 | 0.4 | 114 | 0.4 | 5.8 | Comp. |

*1; Time for adsorption of surfactant
*2; Ratio in weight % of the polymer microparticles containing no pigment in pigment dispersion
*3; MMA/BA/HEMA/MAA = 70/4.3/15/10.7
*4; Pigment disper-sion No.
*5; Adding amount (g)
*6; Volume average particle diameter (nm)
Inv.; Inventive
Comp.; Comparative

Preparation of Pigment Ink

Pigment Inks 1 through 19 having the compositions shown in Table 2 were prepared using the above-prepared Pigment Dispersions 1 through 23.

To each of the pigment dispersions, purified water, 0.3% by weight of Olfin E1010, produced by Nisshin Kagaku Co., Ltd., and the ink solvents shown in Table 2 were added so the concentration of the ink was adjusted to that shown in Table 2. Thus inks were prepared each of which contained the respective pigment dispersion. The adding amount of each of the pigment dispersions was controlled so that the pigment concentration in the ink was 3% by weight. When the concentration of the pigment in the pigment ink cannot be adjusted to 3% by weight because the pigment concentration in the pigment dispersion was insufficient, the dispersion was concentrated by removing water under vacuum. The surface tension of each of the inks was adjusted to the value shown in Table 2 by adding a suitable amount of sodium dodecylsulfate.

The abbreviation of each of the compounds shown in Table 2 was as follows.

EG: Ethylene glycol

GLY: Glycerol

TEGBE: Triethylene glycol monobuthyl ether

HD: 1,2-hexanediol

DEGBE: Diethylene glycol monobutyl ether

DEG: Diethylene glycol

<Determination of Physical Properties of the Ink>

Determination of pH and Viscosity

The pH and viscosity of the inks at 25° C. were each determined by a pH meter HM-30S, manufactured by To a Denpa Kogyo Co., Ltd., and a viscometer Viscomate VM-1AL, manufactured by Yamaichi Denki Co., Ltd., respectively, these apparatus were available on the market.

Determination of Surface Tension

The surface tension at 25° C. of each of the inks was determined by a platinum plate method using a surface tension meter CBVP-Z, manufactured by Kyowa Kaimen Kagaku Co., Ltd.

Determination of the Volume Average Diameter of the Colored Particles in the Pigment Ink

Each of the above-prepared pigment inks was diluted by ultrapure water and the volume average diameter in nm was determined by Zetasizer 1000HS, manufactured by Malburn Co., Ltd.

<Ink-Jet Image Printing>

Output of Image

The above-prepared pigment inks were each charged in an ink cartridge, and Images 1 through 29 were each output onto Ink-jet Paper Photo-like PQ by an on-demand type ink-jet printer, produced by Konica Corp, the maximum recording density was 720×720 dpi. The printer has a piezo type head with a nozzle diameter of 20 μm, a driving frequency of 12 kH, a nozzle number pre color of 128, and a nozzle density between colors of 180 dpi. In the invention, dpi is dot number per 2.54 cm. The out put image was a wedge image in which output density of 0 through 100% was separated into 16 steps. The image was output in the form of patch of 3 cm×3 cm for each density. Besides, the same image was output on Koniclor QA Paper A7 by Digital Mini-lab QD-21 Plus, manufactured by Konica Corp, and developed to prepare a comparative silver halide color photographic image.

Evaluation of Output Image

The above-prepared Images 1 through 29 were evaluated as follows.

Evaluation of Clarity

The above-prepared wedge images were evaluated by comparison with the silver halide color photographic image prepared at the same time to judge that the clarity of the printed image was equal or not to that of the silver halide color photographic image. The evaluation was visually performed by 20 common observer and the evaluation results were classified according to the following norm.

A: The number of the observer how judged that the clarity of the sample was equal to or higher than that of the silver halide photograph was 18 or more.

B: The number of the observer how judged that the clarity of the sample was equal to or higher than that of the silver halide photograph was 15 through 18.

C: The number of the observer how judged that the clarity of the sample was equal to or higher than that of the silver halide photograph was 11 through 14.

D: The number of the observer how judged that the clarity of the sample was equal to or higher than that of the silver halide photograph was 10 or less.

Evaluation of Glossiness

The above-prepared wedge images were evaluated by comparison with the silver halide color photographic image prepared at the same time to judge that the glossiness of the printed image was equal or not to that of the silver halide color photographic image. The evaluation was visually performed by 20 common observer and the evaluation results were classified according to the following norm.

A: The number of the observer how judged that the glossiness of the sample was equal to or higher than that of the silver halide photograph was 18 or more.

B: The number of the observer how judged that the glossiness of the sample was equal to or higher than that of the silver halide photograph was 15 through 18.

C: The number of the observer how judged that the glossiness of the sample was equal to or higher than that of the silver halide photograph was 11 through 14.

D: The number of the observer how judged that the glossiness of the sample was equal to or higher than that of the silver halide photograph was 10 or less.

Evaluation of Resistivity to Frictional Wearing

The patch image having the highest density, output density of 100%, in the wedge image was rubbed 5 times of go and return by an office use eraser MONO, produced by Tombow Pencil Co., Ltd., and the remained image density was visually evaluated by 20 common observer to evaluate the resistivity against frictional wearing. The results were classified according the following norm.

A: The number of the observer how judged that the density of the original image was almost remained is 18 or more.

B: The number of the observer how judged that the density of the original image was almost remained is 15 through 17.

C: The number of the observer how judged that the density of the original image was almost remained is 11 through 14.

D: The number of the observer how judged that the density of the original image was almost remained is 10 or less.

TABLE 2

| | | Ink solvent | | | | | | | | | |
|---|---|---|---|---|---|---|---|---|---|---|---|
| | | | Amount of | | | Surface | | | | | |
| | | Solvent | solvent | Viscosity | | tension | | Results of evaluation | | | |
| *1 | *2 | composition | (weight-%) | (mPa · s) | pH | (mN/m) | *3 | Clarity | Glossness | *4 | Remarks |
| 1 | 1 | EG/GLY/TEGBE | 10/10/10 | 3.2 | 8.2 | 32.0 | 80 | B | A | A | Inv. |
| 2 | 1 | EG/GLY/TEGBE | 5/3/3 | 2.1 | 8.2 | 32.0 | 86 | B | B | A | Inv. |
| 3 | 1 | EG/GLY/TEGBE | 12/5/8 | 3.1 | 8.2 | 32.0 | 82 | B | A | A | Inv. |
| 4 | 1 | EG/GLY/HD | 20/15/15 | 7.8 | 8.2 | 32.0 | 78 | B | A | A | Inv. |
| 5 | 1 | EG/GLY/TEGBE | 10/10/10 | 3.2 | 4.5 | 32.0 | 120 | B | B | B | Inv. |
| 6 | 1 | EG/GLY/TEGBE | 10/10/10 | 3.2 | 10 | 32.0 | 82 | B | A | A | Inv. |
| 7 | 1 | EG/GLY/TEGBE | 10/10/10 | 3.2 | 8.2 | 19.0 | 86 | B | B | B | Inv. |
| 8 | 2 | EG/GLY/TEGBE | 10/10/10 | 3.1 | 8.2 | 32.0 | 92 | C | C | B | Inv. |
| 9 | 3 | EG/GLY/TEGBE | 10/10/10 | 3.2 | 8.2 | 32.0 | 98 | A | A | A | Inv. |
| 10 | 4 | EG/GLY/TEGBE | 10/10/10 | 4.2 | 8.2 | 32.0 | 147 | A | A | A | Inv. |
| 11 | 5 | EG/GLY/TEGBE | 10/10/10 | 3.0 | 8.2 | 32.0 | 86 | A | A | A | Inv. |
| 12 | 6 | EG/GLY/TEGBE | 10/5/15 | 3.2 | 8.2 | 32.0 | 89 | B | A | A | Inv. |
| 13 | 7 | EG/GLY/DEGBE | 10/10/10 | 3.0 | 8.2 | 32.0 | 96 | A | A | A | Inv. |
| 14 | 8 | EG/GLY/HD | 10/10/8 | 3.0 | 8.2 | 32.0 | 88 | B | A | A | Inv. |
| 15 | 9 | EG/GLY/DEGBE | 10/10/10 | 3.8 | 8.2 | 32.0 | 126 | A | A | A | Inv. |
| 16 | 10 | DEG/TEGBE | 15/10 | 2.4 | 8.2 | 32.0 | 98 | A | A | A | Inv. |
| 17 | 11 | EG/GLY/TEGBE | 10/10/10 | 2.9 | 8.2 | 32.0 | 90 | C | B | B | Inv. |
| 18 | 12 | DEG/GLY/TEGBE | 8/10/10 | 4.1 | 8.2 | 32.0 | 126 | A | A | A | Inv. |
| 19 | 13 | DEG/GLY/TEGBE | 8/10/10 | 2.8 | 8.2 | 32.0 | 68 | A | A | A | Inv. |
| 20 | 14 | EG/GLY/TEGBE | 10/10/10 | 3.2 | 8.2 | 32.0 | 100 | A | A | A | Inv. |
| 21 | 15 | EG/GLY/TEGBE | 10/10/10 | 2.9 | 8.2 | 32.0 | 102 | A | A | A | Inv. |
| 22 | 16 | EG/GLY/TEGBE | 10/10/10 | 3.0 | 8.2 | 32.0 | 100 | A | A | A | Inv. |
| 23 | 17 | EG/GLY/TEGBE | 10/10/10 | 3.5 | 8.2 | 32.0 | 132 | C | C | B | Inv. |
| 24 | 18 | EG/GLY/TEGBE | 10/10/10 | 3.1 | 8.2 | 32.0 | 107 | D | D | D | Comp. |
| 25 | 19 | EG/GLY/TEGBE | 10/10/10 | 4.3 | 8.2 | 32.0 | 145 | D | D | D | Comp. |
| 26 | 20 | EG/GLY/TEGBE | 10/10/10 | 2.8 | 8.2 | 32.0 | 128 | D | D | D | Comp. |
| 27 | 21 | EG/GLY/TEGBE | 10/10/10 | 3.9 | 8.2 | 32.0 | 110 | D | D | D | Comp. |
| 28 | 22 | EG/GLY/TEGBE | 10/10/10 | 3.2 | 8.2 | 32.0 | 158 | D | C | B | Comp. |
| 29 | 23 | EG/GLY/TEGBE | 10/10/10 | 3.1 | 8.2 | 31.0 | 118 | D | D | B | Comp. |

*1; Pigment ink & Image No.,
*2; Pigment disper-sion No.
*3; Volume average particle diameter (nm)
*4; Frictional wearing resistivity
Inv.; Inventive
Comp.; Comparative

As is shown in Table 2, the images formed by the inks each containing the color particles prepared by the method of the invention and having the polymer covering ratio according to the invention show good image properties, namely the clarity and glossiness are equal to those of the silver halide color photographic image, and the surface of the images are excellent in the resistivity against the frictional wearing.

### Example 2

Preparation Ink Set

An ink set was prepared which was composed of Pigment Ink 20 (yellow ink), Pigment Ink 9 (magenta ink), Pigment Ink 19 cyan ink), and Pigment Ink 18 (black ink).

The above-prepared ink set was packed in a package designed to keep the deaerated condition, and a full color image was printed out by a color ink-jet printer CL-700, manufactured by Epson Co., Ltd. Besides, the same image was printed out by the use of the original ink set for the printer for comparison. Ink-jet Paper Photo-like QP was used as the recording medium. As the original image, Standard Fine Color Digital Image Data “N5 Bicycle” published by “Nihon Kikaku Kyokai: Foundational Juridical Person” (November 1992) was used. The same data were output on Konica Color QA Paper Type A7 by Digital Mini-lab QD-21 Plus, manufactured by Konica Corp, to prepare a comparative silver halide color photographic image.

The above-prepared images were subjected to evaluation of the clarity, glossiness and frictional wearing resistivity. As the result of the evaluation, it was confirmed that images printed by the ink set composed of the ink-jet inks according to the invention are equal to of the silver halide color photographic image in the clarity, glossiness and are superior to the image printed by the original inks. Moreover, it was also confirmed that the frictional wearing resistivity of the surface of the images according to the invention is excellent.

According to the invention, the aqueous dispersion, the ink for ink-jet printing and the image forming method by the use of the colored microparticles covered by polymer shell having a desired thickness can be provided by which an image excellent in the clarity, glossiness and frictional wearing resistivity can be obtained.

1. A method for forming an aqueous dispersion of colored microparticles comprising a pigment covered with a polymer, wherein the method comprises the steps of:
(a) mixing a hydrophilic colloid or a compound having a hydrophilic portion and a hydrophobic portion with a dispersion of the pigment particle to form a hydrophobic site which is capable of absorbing a monomer compound on a surface of the pigment;
(b) adding a monomer to the mixture obtained by the step (a); and
(c) adding a polymerization initiator to form the polymer on a surface of the pigment particle from the monomer.

2. A method of claim 1, wherein the compound having a hydrophilic portion and a hydrophobic portion to a dispersion of the pigment particle to form a mixture is used in step (a).

3. A method of claim 1, wherein the method further comprises steps after the step (c),
(d) adding another monomer having more hydrophilicity than that of the monomer used in the step of (c), and
(e) adding a polymerization initiator to form a polymer on a surface of the polymer on the pigment particles.

4. A method of claim 1, wherein a ratio A/B of a weight A of the polymer to a weight B of the pigment covered with the polymer is from 0.6 to 10.0.

5. A method of claim 1, wherein the pigment is an organic pigment or carbon black.

6. An aqueous dispersion of a colored microparticle comprising a pigment covered with a polymer, which is prepared by a method comprising the steps of:
(a) mixing a hydrophilic colloid or a compound having a hydrophilic portion and a hydrophobic portion with a dispersion of the pigment particle to form a hydrophobic site which is capable of absorbing a monomer compound on a surface of the pigment;
(b) adding a monomer to the mixture obtained by the step (a); and
(c) adding a polymerization initiator to form the polymer on a surface of the pigment particle from the monomer,
wherein a ratio A/B of a weight A of the polymer to a weight B of the pigment covered with the polymer is from 0.6 to 10.0.

7. An aqueous dispersion of colored microparticles of claim 6, wherein the aqueous dispersion comprises microparticles containing no pigment not more than 1.0% by weight based on the colored particles.

8. The aqueous dispersion of claim 6, wherein the composition of the polymer at the position contacting to the surface of the pigment and that at the outermost portion are different from each other.

9. The aqueous dispersion of claim 6, wherein the volume average diameter of the colored particles is within the range of from 10 nm to 200 nm.

10. The aqueous dispersion of claim 6, wherein the pigment is at least one selected from the group consisting of an azo dye, a quinacridone dye and a phthalocyanine dye.

11. An ink for ink-jet printing containing the aqueous dispersion of claim 6.

12. The ink for ink-jet printing of claim 11 wherein the viscosity of the ink is within the range of from 1.2 mPa·s to 15 mPa·s.

13. The ink for ink-jet printing of claim 11 wherein the surface tension of the ink is within the range of from 20 mN/m to 45 mN/m.

14. The ink for ink-jet printing of claim 11 wherein the pH value of the ink is within the range of from 6.0 to 11.0.

15. The ink for ink-jet printing of claim 11 wherein the content of an ink solvent is within the range of from 10% to 60% by weight based on the ink.

16. An ink-jet image forming method wherein an image is formed by using at least one ink of claim 11.

17. An ink-jet image forming method of claim 16 wherein an image is formed on a porous ink-jet recording medium.
